(19) United States
(12) Patent Application Publication
(10) Pub. No.: US 2013/0319363 A1
(43) Pub. Date: Dec. 5, 2013

(54) JOINT CLIP FOR INTAKE MANIFOLD ASSEMBLY

(71) Applicant: Carl Eric Fonville, Ann Arbor, MI (US)

(72) Inventor: Carl Eric Fonville, Ann Arbor, MI (US)

(73) Assignee: GM GLOBAL TECHNOLOGY OPERATIONS LLC, Detroit, MI (US)

(21) Appl. No.: 13/483,319

(22) Filed: May 30, 2012

(51) Int. Cl. F02M 35/104; B23P 15/00

(52) U.S. Cl. 123/184.61; 123/184.21; 29/890.09

(57) ABSTRACT

An intake manifold assembly includes a first manifold body portion having a first flange, and a second manifold body portion having a second flange. A joint clip defines a channel, with the first flange and the second flange disposed within the channel. The joint clip, the first flange and the second flange are configured so that the joint clip may be freely positioned over the first flange and the second flange in an initial installation position, after which the joint clip is moved under an axial force along a longitudinal axis parallel with the first flange and the second flange into a locking position, in which the first flange and the second flange engage the joint clip in compressive interlocking engagement to secure the first manifold body portion and the second manifold body portion together.

### TECHNICAL FIELD

The invention generally relates to an intake manifold assembly, and more specifically to a joint clip connecting a first manifold body portion to a second manifold body portion, and a method of assembling the intake manifold assembly.

### BACKGROUND

Intake manifold assemblies often include a first manifold body portion that is attached to a second manifold body portion. The first manifold body portion may include but is not limited to a central intake manifold, and the second manifold body portion may include but is not limited to an intake cooler body for a turbocharger system. The first manifold body portion and the second manifold body portion may each include a flange, and be attached together by a bolted connection, in which a plurality of bolts extend through the flanges of the first manifold body portion and the second manifold body portion to secure them relative to each other. However, in some vehicles, assembly and packaging restrictions may prevent the use of such a bolted connection.

### SUMMARY

An intake manifold assembly is provided. The intake manifold assembly includes a first manifold body portion and a second manifold body portion. The first manifold body portion defines a first edge that extends along a longitudinal axis, and includes a first flange that is disposed along the first edge. The first flange extends approximately perpendicularly relative to the first manifold body portion. The first flange defines an inner surface and an outer surface. The second manifold body portion defines a second edge that extends along the longitudinal axis, and includes a second flange that is disposed along the second edge. The second flange extends approximately perpendicular relative to the second manifold body portion. The second flange defines an interior surface and an exterior surface. The outer surface of the first flange is disposed adjacent the exterior surface of the second flange in abutting engagement to define a joint. A joint clip extends along the longitudinal axis. The joint clip includes a base, a first wall and a second wall. The first wall and the second wall extend from the base and are spaced from each other to define a channel. The first flange and the second flange are disposed within the channel of the joint clip in interlocking engagement with the joint clip. The joint clip is moveable in a transverse direction relative to the longitudinal axis to position the first flange and the second flange within the channel of the joint clip in an initial installation position. The joint clip is slideably moveable along the longitudinal axis from the initial installation position into a locking position. When in the locking position, the first wall and the second wall are disposed in compressive interlocking engagement with the first flange and the second flange respectively to compress the first flange and the second flange together, and to secure the first manifold body portion and the second manifold body portion relative to each other.

A method of assembling an intake manifold assembly is also provided. The method includes positioning a first manifold body portion adjacent a second manifold body portion such that a first flange of the first manifold body portion is disposed adjacent a second flange of the second manifold assembly in abutting engagement therebetween to define a joint that extends along a longitudinal axis. A joint clip is moved transverse to the longitudinal axis in a direction substantially perpendicular relative to the first manifold body portion and the second manifold body portion into an initial installation position, wherein the first flange and the second flange are disposed within a channel defined by the joint clip, and a plurality of wall locking features of the joint clip are disposed adjacent a plurality of flange release sections of the first flange and the second flange respectively. The joint clip is slideably moved along the longitudinal axis from the initial installation position into a locking position. When in the locking position, the wall locking features of the joint clip are disposed in compressive interlocking engagement with flange locking features of the first flange and the second flange respectively to compress and secure the first manifold body portion and the second manifold body portion together, and prevent movement of the joint clip in a direction transverse to the longitudinal axis.

Accordingly, the intake manifold assembly provides a compact connection between the first manifold body portion and the second manifold body portion suitable for situations when a bolted connection therebetween is not possible due to packaging restraints. The joint clip is moved into the locking position by sliding the joint clip along the longitudinal axis, parallel with the first manifold body portion and the second manifold body portion, thereby eliminating application of any vertical forces onto either the first manifold body portion or the second manifold body portion, thereby making the installation of the joint clip suitable for use with polymer body portions.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of an intake manifold assembly.

FIG. 2 is a schematic exploded fragmentary plan view of the intake manifold assembly.

FIG. 3 is a schematic fragmentary perspective view of the intake manifold showing a joint clip in an initial installation position.

FIG. 4 is a schematic cross sectional view of the intake manifold assembly taken along cut line 4-4 shown in FIG. 6.

FIG. 5 is a schematic cross sectional view of the intake manifold assembly taken along cut line 5-5 shown in FIG. 6.

FIG. 6 is a schematic fragmentary perspective view of the intake manifold assembly showing the joint clip in a locking position.

FIG. 7 is a schematic cross sectional view of the intake manifold assembly taken along cut line 7-7 shown in FIG. 6.

FIG. 8 is a schematic cross sectional view of the intake manifold assembly taken along cut line 8-8 shown in FIG. 6.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

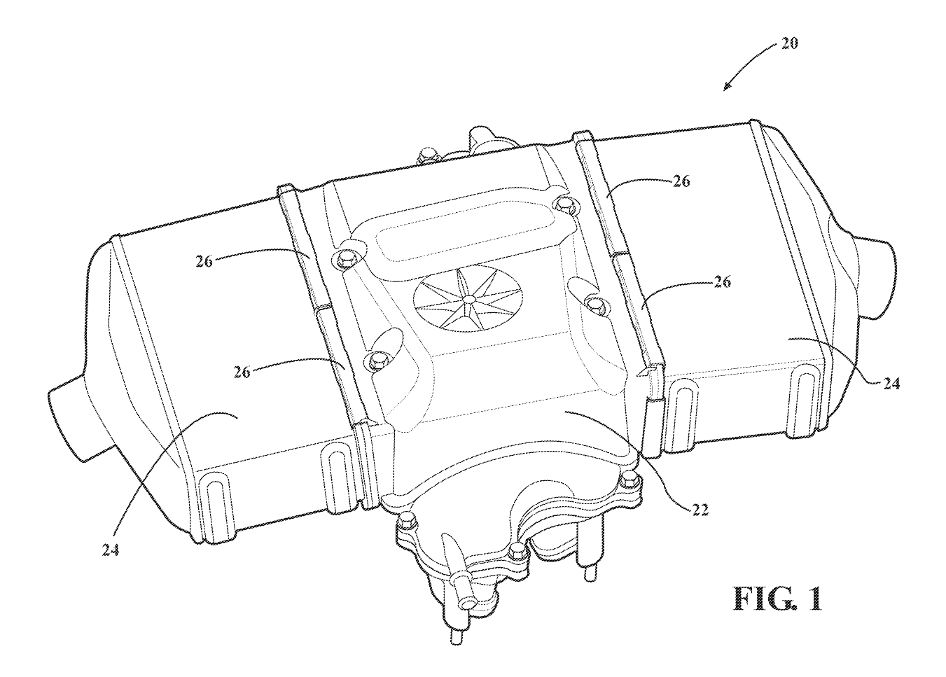

Referring to the Figures, wherein like numerals indicate like parts throughout the several views, an intake manifold assembly is generally shown at 20. Referring to FIG. 1, the intake manifold assembly 20 is for an internal combustion engine of a vehicle, and includes a first manifold body portion 22, a second manifold body portion 24, and at least one joint clip 26 connecting the first manifold body portion 22 and the second manifold body portion 24 together. The first manifold body portion 22 may include, but is not limited to a central manifold housing. The second manifold body portion 24 may include, but is not limited to an intake cooler body. As shown in FIG. 1, the intake manifold assembly 20 includes two intake cooler bodies, disposed on opposite sides of the central manifold housing.

The first manifold body portion 22 and the second manifold body portion 24 may each include and be manufactured from any suitable material. For example, the first manifold body portion 22 may include and be manufactured from a polymer material, i.e., a plastic, whereas the second manifold body portion 24 may include and be manufactured from a metal, such as aluminum. Alternatively, it should be appreciated that both the first manifold body portion 22 and the second manifold body portion 24 may include and be manufactured from a polymer material or a metal material.

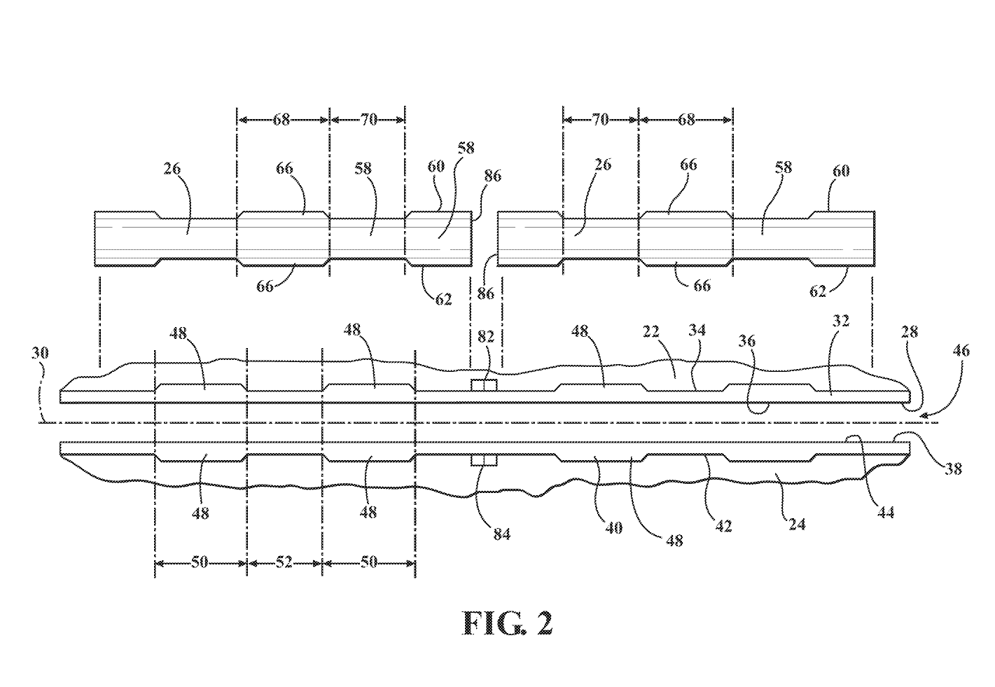

Referring to FIG. 2, the first manifold body portion 22 defines a first edge 28 that extends along a longitudinal axis 30, and further includes a first flange 32 that is disposed along the first edge 28. The first flange 32 extends approximately perpendicularly relative to the first manifold body portion 22, in a transverse direction relative to the longitudinal axis 30. The first flange 32 defines an inner surface 34 and an opposing outer surface 36. The inner surface 34 faces toward the first manifold body portion 22, and the outer surface 36 faces away from the first manifold body portion 22. The second manifold body portion 24 defines a second edge 38 that extends along the longitudinal axis 30, and further includes a second flange 40 that is disposed along the second edge 38. The second flange 40 extends approximately perpendicular relative to the second manifold body portion 24, in a transverse direction relative to the longitudinal axis 30. The second flange 40 defines an interior surface 42 and an exterior surface 44. The interior surface 42 faces toward the second manifold body portion 24, and the exterior surface 44 faces away from the second manifold body portion 24. The outer surface 36 of the first flange 32 is disposed adjacent the exterior surface 44 of the second flange 40 in abutting engagement to define a joint 46 therebetween.

As best shown in FIG. 2, the inner surface 34 of the first flange 32 and the interior surface 42 of the second flange 40 each define a plurality of flange locking features 48. Each of the flange locking features 48 on the inner surface 34 of the first manifold body portion 22 is disposed opposite one of the flange locking features 48 on the interior surface 42 of the second manifold body portion 24 to define a plurality of flange locking sections 50. Each flange locking section 50 is defined by a pair of opposing flange locking features 48 on the first flange 32 and the second flange 40 respectively. In other words, each flange locking section 50 includes one flange locking feature 48 of the first flange 32 positioned opposite and across the longitudinal axis 30 from one of the flange locking feature 48 of the second flange 40. Each of the flange locking features 48 on the first flange 32 and the second flange 40 include a substantially equal length measured along the longitudinal axis 30. The flange locking sections 50 extend a length along the longitudinal axis 30 that is equal to the length of one of the flange locking features 48. The flange locking sections 50 are spaced equidistant from each other along the longitudinal axis 30 to define a plurality of flange release sections 52, with one flange release section 52 disposed between each adjacent pair of flange locking sections 50.

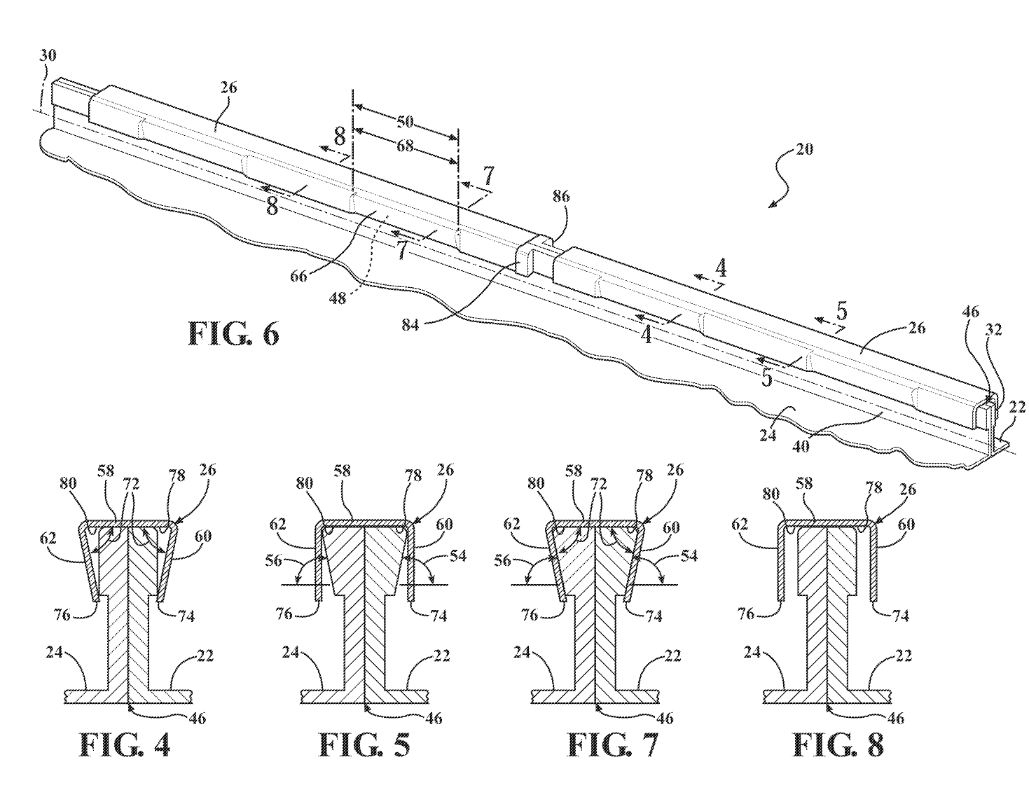

The flange locking features 48 on the first flange 32 and the second flange 40 are defined by the inner surface 34 and the interior surface 42 of the first flange 32 and the second flange 40 respectively. Referring to FIGS. 5 and 7, each of the flange locking features 48 on the first flange 32 extend outward away from the first flange 32 and define an acute angle 54 relative to the first manifold body portion 22. Each of the flange locking features 48 on the second flange 40 extend outward away from the second flange 40 and define an acute angle 56 relative to the second manifold body portion 24. Referring to FIGS. 4 and 8, the sections of the first flange 32 and the second flange 40 disposed between adjacent pairs of locking features on the first flange 32 and the second flange 40 respectively, forming the flange release sections 52, define a substantially vertical surface, and form an approximate perpendicular angle relative to the first manifold body portion 22 and the second manifold body portion 24 respectively.

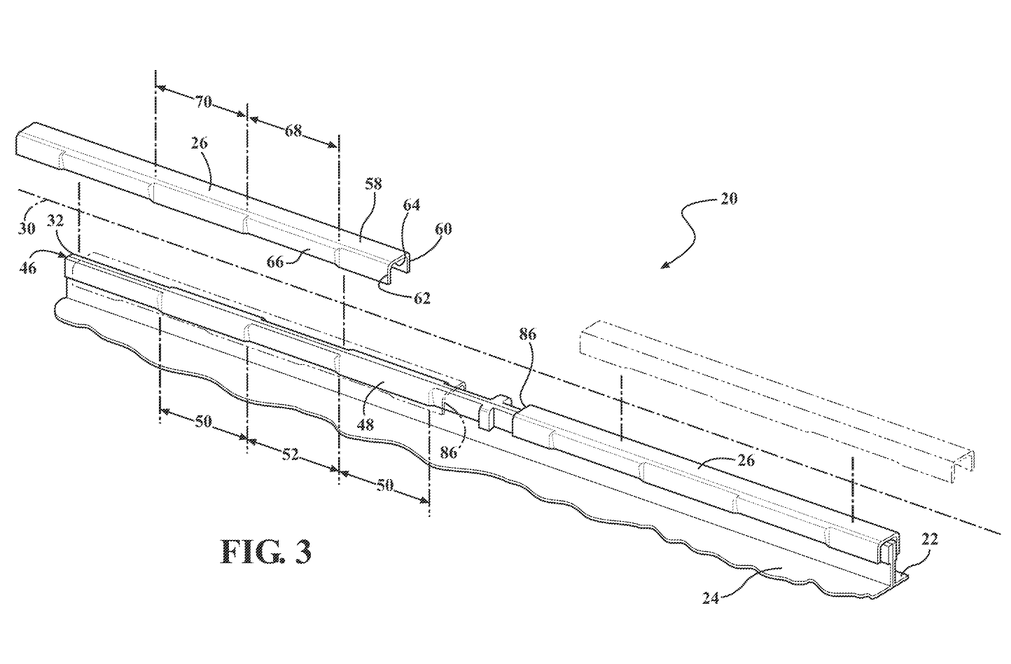

Referring to FIG. 3, the joint clip 26 extends along the longitudinal axis 30 and includes a base 58, a first wall 60 and a second wall 62. The first wall 60 and the second wall 62 extend from the base 58 and are spaced from each other to define a channel 64 therebetween. The joint clip 26 may include a plurality of joint clips 26 spaced along the joint 46 between the first manifold body portion 22 and the second manifold body portion 24.

Referring to FIG. 2, the first wall 60 and the second wall 62 of the joint clip 26 each define a plurality of wall locking features 66. Each wall locking feature 66 on the first wall 60 is disposed opposite one of the wall locking features 66 on the second wall 62 to define a plurality of wall locking sections 68. Each wall locking section 68 is defined by a pair of opposing wall locking features 66 on the first wall 60 and the second wall 62 respectively. In other words, each wall locking section 68 includes one wall locking feature 66 of the first wall 60 positioned opposite and across the longitudinal axis 30 from one wall locking feature 66 of the second wall 62. Each of the wall locking features 66 on the first wall 60 and the second wall 62 include a substantially equal length measured along the longitudinal axis 30. The length of each of the wall locking features 66 is substantially equal to the length of each of the flange locking features 48. The wall locking sections 68 extend a length along the longitudinal axis 30 that is equal to the length of one of the wall locking features 66. Furthermore, the length of the wall locking sections 68 is approximately equal to the length of each of the flange locking sections 50. The wall locking sections 68 are spaced equidistant from each other along the longitudinal axis 30 to define a plurality of wall release sections 70, with one wall release section 70 disposed between each adjacent pair of wall locking sections 68. The length of each wall release section 70 is approximately equal to the length of the flange release sections 52 and the flange locking sections 50.

Referring to FIGS. 4 and 7, each of the wall locking features 66 extend from the base 58 inward toward the channel 64, and define an acute angle 72 relative to the base 58. Referring to FIGS. 5 and 8, the sections of the first wall 60 and the second wall 62 disposed between adjacent pairs of wall locking features 66 on the first wall 60 and the second wall 62 respectively, thereby forming the wall release sections 70, include a substantially vertical wall section that is disposed at an approximate perpendicular angle relative to the base 58 of the joint clip 26.

In order to assemble the intake manifold assembly 20, the first manifold body portion 22 is positioned adjacent the second manifold body portion 24 such that the first flange 32 of the first manifold body portion 22 is disposed adjacent the second flange 40 of the second manifold assembly in abutting engagement therebetween to define the joint 46 that extends along the longitudinal axis 30, with the flange locking features 48 on the first flange 32 disposed opposite the flange locking features 48 on the second flange 40 to define the flange locking sections 50.

Once the first manifold body portion 22 is positioned relative to the second manifold body portion 24, the joint clip 26 is moved into or positioned in an initial installation position, shown in phantom in FIG. 3. In order to position the joint clip 26 in the initial installation position, the joint clip 26 is moved generally perpendicularly toward the first manifold body portion 22 and the second manifold body portion 24, in a transverse direction relative to the longitudinal axis 30, thereby positioning the first flange 32 and the second flange 40 within the channel 64 of the joint clip 26. Referring to FIGS. 4 and 5, when moving the joint clip 26 into the initial installation position, the wall release sections 70 of the joint clip 26 slide over the flange locking sections 50 of the first flange 32 and the second flange 40 respectively, and the wall locking sections 68 of the joint clip 26 slide over the flange release sections 52 of the first flange 32 and the second flange 40 respectively. The wall release sections 70 of the joint clip 26 slide over the flange locking sections 50 freely, with minimal or no downward force applied to the joint clip 26.

The joint clip 26 is slideably moveable along the longitudinal axis 30 from the initial installation position into a locking position, shown in FIG. 6. The first flange 32 and the second flange 40 are disposed within the channel 64 of the joint clip 26 in interlocking engagement with the joint clip 26 when the joint clip 26 is disposed in the locking position. More specifically, the first wall 60 and the second wall 62 are disposed in compressive interlocking engagement with the first flange 32 and the second flange 40 respectively to compress the first flange 32 and the second flange 40 together and secure the first manifold body portion 22 and the second manifold body portion 24 relative to each other. As the joint clip 26 is moved from the initial installation position into the locking position, the wall locking sections 68 on the joint clip 26 engage the flange locking sections 50 on the first flange 32 and the second flange 40 respectively, thereby spreading the wall locking features 66 outward, which generates a compressive force directed inward toward the first flange 32 and the second flange 40 respectively to secure the first flange 32 and the second flange 40 together. Referring to FIG. 7, each of the wall locking sections 68 of the joint clip 26 is aligned with and disposed adjacent one of the flange locking sections 50 when the joint clip 26 is disposed in the locking position. The wall locking sections 68 and the flange locking sections 50 engage each other to define a dovetail connection therebetween, which resists movement of the joint clip 26 transverse to the longitudinal axis 30.

The joint clip 26 is configured for slideable movement along the longitudinal axis 30 into the locking position in response to an applied axial force. Preferably, the applied force is between the range of 25 lbs and 45 lbs. However, it should be appreciated that applied axial force may differ from the range provided depending upon the specific conditions and performance requirements to be met. The joint clip 26 may be manually placed in the initial installation position, and then moved into the locking position by application of the axial force, which is preferably applied by a mechanical press or some other similar device. Preferably, such as shown in FIG. 1, a pair of joint clips 26 is installed on each joint 46. Each of the joint clips is identical, including an equal length along the joint. The pair of joint clips 26 is installed simultaneously from opposing directions so as to place zero reaction load on the intake manifold assembly 29 during the installation process. In other words, each of the joint clips 26 are simultaneously pressed toward the other into their respective locking positions to offset the loads applied to the intake manifold assembly 20 from each of the joint clips 26.

As shown in FIGS. 4, 5, 7 and 8, a distal edge 74 of the first wall 60 and a distal edge 76 of the second wall 62 are spaced from the first manifold body portion 22 and the second manifold body portion 24 respectively when the joint clip 26 is positioned in either the initial installation position or the locking position. Furthermore, a distal edge 78 of the first flange 32 and a distal edge 80 of the second flange 40 engage the base 58 of the joint clip 26 in abutting engagement when the joint clip 26 is disposed in either the initial installation position or the locking position.

The first flange 32 may include a first stop 82 disposed on the inner surface 34 of the first flange 32. Similarly, the second flange 40 may include a second stop 84 disposed on the interior surface 42 of the second flange 40. The first stop 82 and/or the second stop 84 are positioned to prevent the slideable movement of the joint clip 26 beyond the locking position. As such, upon application of the applied force to the joint clip 26, the joint clip 26 moves from the initial installation position into the locking position, whereupon the joint clip 26 encounters the first stop 82 and/or the second stop 84, which prevents further movement along the longitudinal axis 30 to ensure the joint clip 26 is properly positioned in the locking position. The first stop 82 and/or the second stop 84 may be shaped so as to provide access to a longitudinal end 86 of the joint clip 26, which may be engaged by a tool to drive the joint clip 26 backwards from the locking position into the initial installation position, whereupon the joint clip 26 may be removed.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An intake manifold assembly comprising:
a first manifold body portion defining a first edge extending along a longitudinal axis, and including a first flange disposed along the first edge and extending approximately perpendicularly relative to the first manifold body portion, wherein the first flange defines an inner surface and an outer surface;
a second manifold body portion defining a second edge extending along the longitudinal axis, and including a second flange disposed along the second edge and extending approximately perpendicularly relative to the second manifold body portion, wherein the second flange defines an interior surface and an exterior surface;
wherein the outer surface of the first flange is disposed adjacent to and in abutting engagement with the exterior surface of the second flange to define a joint; and
a joint clip extending along the longitudinal axis and having a base, a first wall and a second wall, wherein the first wall and the second wall extend from the base and are spaced from each other to define a channel, with the first flange and the second flange disposed within the channel of the joint clip in interlocking engagement with the joint clip;
wherein the joint clip is moveable in a transverse direction relative to the longitudinal axis to position the first flange and the second flange within the channel of the joint clip in an initial installation position; and
wherein the joint clip is slideably moveable along the longitudinal axis from the initial installation position into a locking position, wherein the first wall and the second wall disposed in compressive interlocking engagement with the first flange and the second flange respectively when in the locking position to compress the first flange and the second flange together, and to secure the first manifold body portion and the second manifold body portion relative to each other.

2. An intake manifold assembly as set forth in claim 1 wherein the inner surface of the first flange and the interior surface of the second flange each define a plurality of flange locking features, with each flange locking feature on the inner surface disposed opposite one flange locking feature on the interior surface to define a plurality of flange locking sections, and with the flange locking sections spaced equidistant from each other along the longitudinal axis to define a flange release section between each adjacent pair of flange locking sections.

3. An intake manifold assembly as set forth in claim 2 wherein the first wall and the second wall of the joint clip each define a plurality of wall locking features, with each wall locking feature on the first wall disposed opposite one wall locking feature on the second wall to define a plurality of wall locking sections, and with the wall locking sections spaced equidistant from each other along the longitudinal axis to define a wall release section between each adjacent pair of wall locking sections.

4. An intake manifold assembly as set forth in claim 3 wherein each of the wall locking sections of the joint clip is aligned with and disposed adjacent one of the flange release sections when the joint clip is disposed in the initial installation position, and wherein each of the wall locking sections of the joint clip is aligned with and disposed adjacent one of the flange locking sections when the joint clip is disposed in the locking position.

5. An intake manifold assembly as set forth in claim 3 wherein each of the wall locking features extend from the base inward toward the channel, and define an acute angel relative to the base.

6. An intake manifold assembly as set forth in claim 5 wherein each of the flange locking features on the first flange extend outward away from the first flange and define an acute angle relative to the first manifold body portion, and wherein each of the flange locking features on the second flange extend outward away from the second flange and define an acute angle relative to the second manifold body portion.

7. An intake manifold assembly as set forth in claim 6 wherein the wall locking sections and the flange locking sections engage each other to define a dovetail connection therebetween when the joint clip is disposed in the locking position to resist movement of the joint clip transverse to the longitudinal axis.

8. An intake manifold assembly as set forth in claim 3 wherein each of the flange locking features and the wall locking features include a substantially equal length measured along the longitudinal axis.

9. An intake manifold assembly as set forth in claim 8 wherein each of the wall locking sections, the wall release sections, the flange locking sections and the flange release sections include a substantially equal length measured along the longitudinal axis.

10. An intake manifold assembly as set forth in claim 3 wherein a distal edge of the first wall and a distal edge of the second wall are spaced from the first manifold body portion and the second manifold body portion respectively.

11. An intake manifold assembly as set forth in claim 10 wherein a distal edge of the first flange and a distal edge of the second flange engage the base portion of the joint clip in abutting engagement when the joint clip is disposed in the locking position.

12. An intake manifold assembly as set forth in claim 1 wherein the joint clip is freely moveable into the initial installation position, and wherein the joint clip is configured for slideable movement along the longitudinal axis into the locking position in response to an applied axial force.

13. An intake manifold assembly as set forth in claim 12 wherein the applied force is between the range of 25 lbs and 45 lbs.

14. An intake manifold assembly as set forth in claim 1 wherein the first flange includes a first stop disposed on the inner surface of the first flange and positioned to prevent the slideable movement of the joint clip beyond the locking position.

15. An intake manifold assembly as set forth in claim 14 wherein the second flange includes a second stop disposed on the interior surface of the second flange and positioned to prevent the slideable movement of the joint clip beyond the locking position.

16. An intake manifold assembly as set forth in claim 1 wherein the joint clip includes a plurality of joint clips spaced along the joint between the first manifold body portion and the second manifold body portion.

17. An intake manifold assembly as set forth in claim 1 wherein at least one of the first manifold body portion and the second manifold body portion include and are manufactured from a polymer material.

18. A method of assembling an intake manifold assembly, the method comprising:
positioning a first manifold body portion adjacent a second manifold body portion such that a first flange of the first manifold body portion is disposed adjacent a second flange of the second manifold assembly in abutting engagement therebetween to define a joint that extends along a longitudinal axis;
moving a joint clip transverse to the longitudinal axis in a direction substantially perpendicular relative to the first manifold body portion and the second manifold body portion into an initial installation position, wherein the first flange and the second flange are disposed within a channel defined by the joint clip, and wherein a plurality of wall locking features of the joint clip are disposed adjacent a plurality of flange release sections of the first flange and the second flange respectively; and
slideably moving the joint clip along the longitudinal axis from the initial installation position into a locking position, wherein the wall locking features of the joint clip are disposed in compressive interlocking engagement with flange locking features of the first flange and the second flange respectively to compress and secure the first manifold body portion and the second manifold body portion together, and prevent movement of the joint clip in a direction transverse to the longitudinal axis.

19. A method as set forth in claim 18 further comprising applying an axial force to the joint clip along the longitudinal axis to move the joint clip from the initial installation position into the locking position, wherein the axial force is between the range of 25 lbs and 45 lbs.

20. A method as set forth in claim 18 wherein each of the wall locking features, the flange locking features and the flange release sections include a length measured along the longitudinal axis that is substantially equal to each other, and wherein slideably moving the joint clip along the longitudinal axis from the initial installation position into the locking position includes moving the joint clip a distance substantially equal to the length of the wall locking features, the flange locking features and the flange release sections.
